(19) United States
(12) Patent Application Publication
(10) Pub. No.: US 2007/0095571 A1
(43) Pub. Date: May 3, 2007

(54) Door grommet for vehicle

(75) Inventor: In Ho Kim, Ulsan Metropolitan City (KR)

Correspondence Address: EDWARDS & ANGELL, LLP, P.O. BOX 55874, BOSTON, MA, 02205, US

(73) Assignee: Hyundai Motor Company, Seoul (KR)

(21) Appl. No.: 11/298,644

(22) Filed: Dec. 8, 2005

(30) Foreign Application Priority Data
Oct. 31, 2005 (KR) 2005-0103492

(51) Int. Cl. H02G 3/18

(52) U.S. Cl. 174/665

(57) ABSTRACT

A door grommet installed in a door of a vehicle is disclosed and may preferably comprise a guide clip (i) engaged to a connector and (ii) engaged to wiring in communication with the connector. Preferred door grommets of the invention may prevent wiring installed in the door grommet from being undesirably twisted. Additionally, with preferred door grommets of the invention a worker can recognize in advance the engagement directions of a connector provided in the door grommet and a counter-connector provided in a panel by using a guide clip installed in the connector of the door grommet in an assembling line of a vehicle, thereby restricting the direction of the door grommet, improving worker efficiency, and facilitating repair operations.

### CROSS-REFERENCE TO RELATED APPLICATION

This application claims priority to and the benefit of Korean Patent Application 10-2005-0103492 filed in the Korean Intellectual Property Office on Oct. 31, 2005, the entire content of which is incorporated herein by reference.

### FIELD OF THE INVENTION

The present invention relates to a door grommet for a vehicle which may suitably comprise one or more guide clips (i) engaged to a connector and (ii) engaged to wiring in communication with the connector. In preferred systems, wiring installed in the door grommet can be prevented from being twisted and in which a worker can recognize in advance the engagement directions of a connector provided in the door grommet and a counter-connector provided in a panel, by using a guide clip installed in the connector of the door grommet in an assembling line of a vehicle, thereby restricting the direction of the door grommet, improving working efficiency, and facilitating repair operations.

### BACKGROUND

Generally, many electric parts, such as a power window glass switch, are installed in a door of a vehicle, and many wire cables for supplying electricity to the electric parts are installed from the body of the vehicle toward the door.

Conventionally, when the wire cables are installed on the door side, a grommet is used to connect the wire cables to a door connector.

The grommet is installed in a vehicle, and wiring is received in the grommet. The grommet is used to protect the wiring from foreign substances and objects, which are introduced from the outside of the vehicle, and to prevent dust etc., from being introduced into a connector engaged with the wiring.

When general grommets are installed to various parts of a vehicle, they are treated while exposing the wiring in the grommet, thereby increasing the time required for the installation.

In addition, since a worker must construct a vehicle during the assembling process, with his one hand grasping wiring, accurate manipulation of the connector can be difficult.

A door grommet installed in a door of a vehicle can have particular disadvantages in addition to those of a general grommet.

Thus, in assembly processes, a worker draws wiring toward the interior of the vehicle, and it can be difficult to position wiring into a panel, which may in turn require the worker to utilize excessive manual force, thereby compromising the worker's efficiency over time.

Additionally, since sealing is maintained depending on the adhering force of the grommet, inferior sealing properties can arise from the grommet. Further, with current door grommets, repair can be inconvenient and engaged connectors can be difficult to release.

The information set forth in this Background of the Invention section is only for enhancement of understanding of the invention and should not be taken as an acknowledgement or any form of suggestion that this information forms the prior art that is already known to a person skilled in the art.

### SUMMARY OF THE INVENTION

In one aspect, a door grommet for a vehicle is provided which can prevent wiring installed in a door grommet from being twisted, by installing a guide clip which can be engaged with an existing connector, and which can improve working efficiency and facilitate repair operations.

Preferred vehicle door grommets of the invention may comprise one or more guide clips (i) engaged to a connector and (ii) engaged to wiring in communication with the connector.

In a preferred aspect, a door grommet for a vehicle is provided comprising: a guide clip having one end engaged through the rear surface of a connector and the other end fixed to a wiring ring engaged with the connector, the guide clip being accommodated in the door grommet which is to be installed in a vehicle.

Particularly preferred guide clips comprise insertion portions provided at one end thereof and which are engaged with the inner side of the connector, a horizontal portion integrally formed with the insertion portions and extending backward, and a vertical portion integrally formed with the horizontal portion and formed by bending an end of the guide clip downward.

In preferred systems, a preventing portion protruding outward is formed at the tip end of the horizontal portion.

Also in preferred systems the vertical portion of the guide clip is bent and is fixed to the wiring.

The guide clip also may be suitably engaged with the left or right side of the connector. In the case of a left-hand drive vehicle, the guide clip is suitably engaged with the left side of the connector, and in the case of a right-hand drive vehicle, the guide clip is suitably engaged with the right side of the connector.

The invention also includes vehicles and vehicle components (such as vehicle door grommets and vehicle door units) that comprise one or more guide clips as described herein. The invention also includes vehicles and vehicle components that comprise one or more grommets as described herein.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like. The present grommets and guide clips will be particularly useful with a wide variety of motor vehicles including automobiles, trucks and the like.

Other aspects of the invention are discussed below.

### BRIEF DESCRIPTION OF THE DRAWINGS

The above and other objects, features and advantages of the present invention will be more apparent from the following detailed description taken in conjunction with the accompanying drawings, in which:

FIG. 1 is a view for showing a guide clip installed in a door grommet for a vehicle according to the present invention;

FIGS. 2a and 2b are views for showing the states in which a connector, a guide clip, and a grommet are engaged; and

FIGS. 3a and 3b are views for showing the states in which a door grommet for a vehicle according to the present invention is installed in a vehicle.

### DETAILED DESCRIPTION OF THE INVENTION

As discussed above, preferred vehicle door grommets of the invention may comprise one or more guide clips (i) engaged to a connector and (ii) engaged to wiring in communication with the connector.

Particularly preferred guide clips comprise insertion portions provided at one end thereof and which are engaged with the inner side of a connector. Such preferred guide clips also preferably comprise a horizontal portion integrally formed with the insertion portions and extending backward. Such preferred guide clips also may preferably comprise a vertical portion integrally formed with the horizontal portion and formed by bending an end of the guide clip downward.

A preferred embodiment of the present invention is now described with reference to the accompanying drawings.

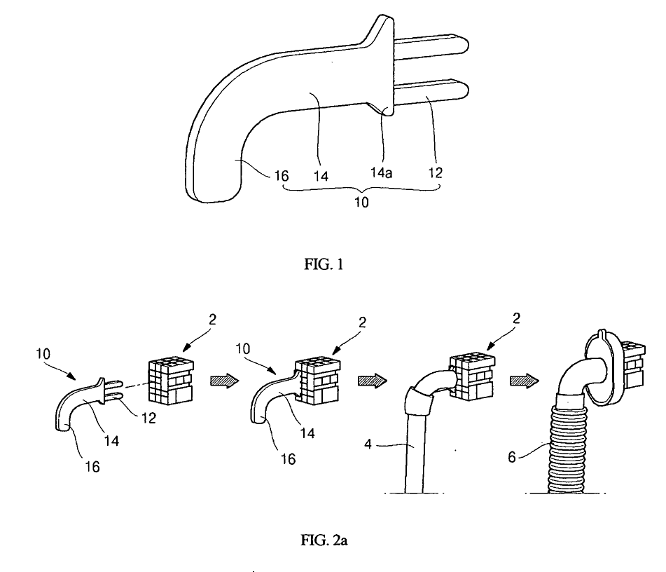

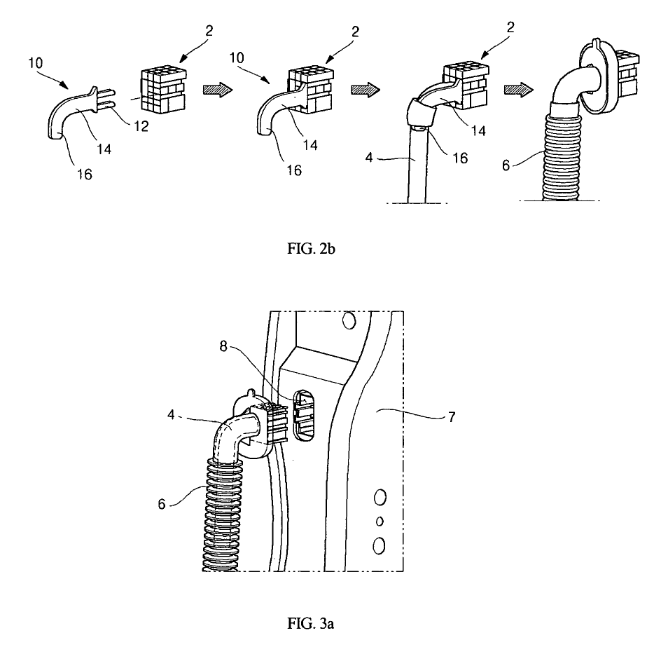

Referring to FIGS. 1 and 2a, a preferred guide clip 10 suitably has one end engaged through the rear surface of a connector 2 and the other end fixed to a wiring 4 engaged with the connector 2.

The guide clip 10 preferably includes insertion portions 12 provided at one end thereof and engaged with the inner side of the connector 2, a horizontal portion 14 integrally formed with the insertion portions 12 and extending backward, and a vertical portion 16 integrally formed with the horizontal portion 14 and formed by bending an end of the guide clip 10 downward.

A preventing portion 14a protruding to the outside is preferably formed at the tip end of the horizontal portion 14.

The vertical portion 16 of the guide clip 10 is preferably bent and fixed to the wiring 4.

The guide clip 10 is suitably engaged with the left or right side of the connector 2. As discussed above, in the case of a steering wheel of a left-hand drive vehicle, the guide clip 10 is suitably engaged with the left side of the connector 2, and in the case of a steering wheel of a right-hand drive vehicle, the guide clip 10 is suitably engaged with the right side of the connector 2.

Preferred processes in which the door grommet according to the present invention is engaged and a state in which the door grommet is installed to a vehicle are now described in detail with reference to the drawings.

FIG. 2a shows guide clip 10, the connector 2, and the door grommet 6 engaged in the case of a steering wheel of a left-hand drive vehicle, and the worker engages the insertion portions 12 of the guide clip 10 with the interior of the rear surface of the connector 2.

The insertion portions 12 protrudes to the front, and has a length long enough to be inserted into the connector 2, so as to be engaged with the inner side of the connector 2.

If the insertion portions 12 are engaged with the connector 2, the insertion portions 12 are prevented from being inserted further into the interior of the connector 2 by the preventing portion 14a, and the preventing portion 14a is adhered to the rear surface of the connector 2.

In this configuration, the worker engages one end of the wiring 4 with the connector 2, and fixes the vertical portion 16 of the guide clip 10 to the wiring 4 by using a separate attachment member (i.e. tape, a bend cable, etc.).

Once the wiring 4 is fixed to the vertical portion 16, the wiring 4 is prevented from twisted or moved to another location during the work.

In this configuration, the worker can install the door grommet 6 to the wiring 4, to which the guide clip 10 is fixed to complete the assembly process.

Since in the case of the left hand drive vehicle, a terminal (not shown) provided in the connector 2 is located on the left side, the guide clip 10 is installed on the left side of the connector 2, as shown in FIG. 2a.

FIG. 2b shows guide clip 10, the connector 2, and the door grommet 6 engaged in the case of a steering wheel of a right-hand drive vehicle, and the worker engages the insertion portions 12 of the guide clip 10 with the interior of the rear surface of the connector 2.

If the insertion portions 12 are engaged with the connector 2, the preventing portion 14a of the tip end of the horizontal portion 14 is adhered to the rear surface of the connector 2.

In this configuration, the worker engages one end of the wiring 4 with the connector 2, and fixes the vertical portion 16 of the guide clip 10 to the wiring 4 by using a separate attachment member (i.e. tape, a band cable, etc.).

Once the wiring 4 is fixed to the vertical portion 16, the wiring 4 is prevented from being twisted or moved to another location during the work.

In this configuration, the worker installs the door grommet 6 to the wiring 4 to which the guide clip 10 is fixed to complete the assembly process.

Since in the case of the right hand drive vehicle, a terminal (not shown) provided in the connector 2 is located on the right side, the guide clip 10 is installed on the right side of the connector 2.

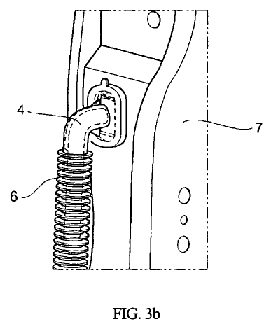

Referring now to FIG. 3a, in the configuration in which the guide clip 10 and the wiring 4 are fixed to the interior of the door grommet 6, the worker can grasp with his or her the downwardly bent portion of the door grommet 6 and then insert the door grommet 6 into an insertion hole 8 formed in an outer panel 7 of a vehicle.

Since the guide clip 10 is already installed in the door grommet 6 and, after confirming the positions of the insertion portions 12 of the guide clip 10, the insertion portions 12 are inserted into the insertion hole 8, the direction of the door grommet 6 can be recognized in advance.

Although not shown in the figures, an engagement connector (not shown) engaged with the connector 2 can be installed on the side opposite to the insertion hole 8 into which the door grommet 6 is inserted.

Referring to FIG. 3b, if the connector 2 is engaged with the interior of the insertion hole 8, the work is completed as shown in the figure.

As mentioned above, the door grommet for a vehicle according to the present invention can be used without changing the mold of the existing connector, and restricts the direction of the connector when engaged with an outer panel of the vehicle, thereby improving worker efficiency.

Further, since the wire received in the door grommet can be prevented from being twisted, productivity can be enhanced and future repairs potentially reduced.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A door grommet for a vehicle comprising:
a guide clip having one end engaged through the rear surface of a connector and another end fixed to a wiring ring engaged with the connector.

2. A door grommet according to claim 1, wherein the guide clip comprises insertion portions provided at one end thereof and engaged with the inner side of the connector, a horizontal portion integrally formed with the insertion portions and extending backward, and a vertical portion integrally formed with the horizontal portion and formed by bending an end of the guide clip downward.

3. A door grommet according to claim 2, wherein a preventing portion protruding outward is formed at the tip end of the horizontal portion.

4. A door grommet according to claim 1, wherein the vertical portion of the guide clip is fixed to the wiring by using an attachment member.

5. A door grommet according to claim 1, wherein the guide clip is engaged with the left or right side of the connector.

6. A door grommet according to claim 1, wherein in the case of a steering wheel of a left-hand drive vehicle, the guide clip is engaged with the left side of the connector, and in the case of a steering wheel of a right-hand drive vehicle, the guide clip is engaged with the right side of the connector.

7. A vehicle door grommet comprising:
a guide clip (i) engaged to a connector and (ii) engaged to wiring in communication with the connector.

8. A vehicle comprising a door grommet of claim 1.

9. The vehicle of claim 8 wherein the vehicle is a left-hand drive vehicle and the guide clip is engaged to the left side of the connector.

10. The vehicle of claim 8 wherein the vehicle is a right-hand drive vehicle and the guide clip is engaged to the right side of the connector.

11. A vehicle comprising a door grommet of claim 7.

12. The vehicle of claim 11 wherein the vehicle is a left-hand drive vehicle and the guide clip is engaged to the left side of the connector.

13. The vehicle of claim 11 wherein the vehicle is a right-hand drive vehicle and the guide clip is engaged to the right side of the connector.
